(19) United States
(12) Patent Application Publication
(10) Pub. No.: US 2019/0049809 A1
(43) Pub. Date: Feb. 14, 2019

(54) ELECTROCHROMIC ELEMENT

(71) Applicant: AGC Inc., Chiyoda-ku (JP)

(72) Inventors: Takuji OYAMA, Chiyoda-ku (JP); Teppei KONISHI, Chiyoda-ku (JP); Shinya TAHARA, Chiyoda-ku (JP); Hiroshi KUMAI, Chiyoda-ku (JP)

(73) Assignee: AGC Inc., Chiyoda-ku (JP)

(21) Appl. No.: 16/162,967

(22) Filed: Oct. 17, 2018

Related U.S. Application Data
(63) Continuation of application No. PCT/JP2017/018468, filed on May 17, 2017.

(30) Foreign Application Priority Data
May 18, 2016 (JP) 2016-099757

(51) Int. Cl. G02F 1/15; G02F 1/153; G02F 1/157

(52) U.S. Cl. CPC G02F 1/1525; G02F 1/157; G02F 1/1533; G02F 1/1508

(57) ABSTRACT

An electrochromic element which suppresses ripples in a color-reduction state and with which good visible light transmittance can be obtained is provided. An electrochromic element 100 includes: a transparent electrolyte layer 110; a pair of solid electrochromic layers which sandwiches the transparent electrolyte layer and is constituted by a pair of a reduction coloring-type solid electrochromic layer 120 and an oxidation coloring-type solid electrochromic layer 130 opposing each other, and a pair of transparent conductive films 140, where in the thickness and refractive indexe with respect to light at a wavelength of 550 nm about the transparent electrolyte layer 140, the reduction coloring-type solid electrochromic layer 120 and the oxidation coloring-type solid electrochromic layer 130, those values are provided so as to satisfy predetermined relations to suppress the ripples.

### CROSS-REFERENCE TO RELATED APPLICATIONS

This application is a continuation of prior International Application No. PCT/JP2017/018468, filed on May 17, 2017 which is based upon and claims the benefit of priority from Japanese Patent Application No. 2016-099757, filed on May 18, 2016; the entire contents of all of which are incorporated herein by reference.

### FIELD

The present invention relates to an electrochromic element which is applied to various optical elements such as an ND filter and capable of controlling transmittance, in more detail, to an electrochromic element suppressing ripples in a color-reduction state.

### BACKGROUND

An electrochromic material is a compound having electrochromic properties, and a compound whose transmittance changes according to a change in electrical states thereof. There has been known an electrochromic element capable of controlling a change in visible light transmittance by applying a voltage by using characteristics of the electrochromic material. The electrochromic element is generally an element constituted by disposing the electrochromic material and an electrolyte between a pair of electrodes, and for example, there is an ND filter or the like as a product applying the electrochromic element.

The electrochromic element preferably has high uniformity in visible light transmittance under a color-reduction state. As a method to increase the uniformity, an art has been publicly known where the uniformity is increased by, for example, substantially equalizing a first, a second, and a third refractive index when the electrochromic material has the first refractive index, the electrode couple has the second refractive index, and the electrolyte (an ion conductive layer) has the third refractive index (for example, refer to Japanese Patent No. 3603963).

### SUMMARY

When flexibility of combinations between the electrochromic materials and electrolyte materials to obtain desired characteristics is considered, a majority of the combinations between the electrochromic materials and the electrolyte materials is a relationship having different refractive indexes. Accordingly, the number of choices of the combinations of the materials where the refractive indexes are substantially equalized is extremely narrow, and diversity of element characteristics cannot be obtained.

An object of the present invention is to provide an electrochromic element capable of suppressing ripples in a color-reduction state and obtaining good visible light transmittance even when refractive indexes of an electrochromic material and an electrolyte material are different.

An electrochromic element according to the present invention includes: a transparent electrolyte layer; a pair of solid electrochromic layers which sandwiches the transparent electrolyte layer, the pair of solid electrochromic layers being constituted by a pair of a reduction coloring-type solid electrochromic layer and an oxidation coloring-type solid electrochromic layer; a pair of transparent conductive films which further sandwiches the pair of solid electrochromic layers, and transparent support substrates which respectively support the pair of transparent conductive films, wherein the pair of solid electrochromic layers is constituted by a reduction coloring-type solid electrochromic layer and an oxidation coloring-type solid electrochromic layer opposing each other, and wherein the electrochromic element satisfies: n0 is different from either of n1 and n2, d0 is 5 μm or more, and d1 and d2 are provided to satisfy |λa−λb|≤50 nm, where d0 is a thickness of the transparent electrolyte layer, n0 is a refractive index of the transparent electrolyte layer with respect to light at a wavelength of 550 nm, d1 is a thickness of the reduction coloring-type solid electrochromic layer, n1 is a refractive index of the reduction coloring-type solid electrochromic layer with respect to light at a wavelength of 550 nm, d2 is a thickness of the oxidation coloring-type solid electrochromic layer, n2 is a refractive index of the oxidation coloring-type solid electrochromic layer with respect to light at a wavelength of 550 nm, λa is a wavelength representing a maximum or a minimum which is the nearest to the wavelength of 550 nm in a spectral transmission spectrum due to interference of a stack having the transparent support substrate, the transparent conductive film, the reduction coloring-type solid electrochromic layer, and the transparent electrolyte layer in this order, and λb is a wavelength representing a minimum or a maximum which is the nearest to the wavelength of 550 nm in a spectral transmission spectrum due to interference of a stack having the transparent electrolyte layer, the oxidation coloring-type solid electrochromic layer, the transparent conductive film, and the transparent support substrate in this order, where a corresponding wavelength is selected such that when λa is the maximum, λb is the minimum, and when λa is the minimum, λb is the maximum.

### BRIEF DESCRIPTION OF THE DRAWINGS

FIG. 1 is a schematic sectional view of an electrochromic element being an embodiment of the present invention.

FIG. 2 is a schematic sectional view of an electrochromic element being an embodiment of the present invention.

FIG. 3 is a graph illustrating a simulation data obtained in Example 1.

FIG. 4 is a graph illustrating a simulation data obtained in Example 2.

FIG. 5 is a graph illustrating a simulation data obtained in Example 3.

FIG. 6 is a graph illustrating a simulation data obtained in Example 4.

FIG. 7 is a graph illustrating a simulation data obtained in Example 5.

FIG. 8 is a graph illustrating a simulation data obtained in Example 6.

### DETAILED DESCRIPTION

Hereinafter, an electrochromic element of the present invention is described in detail with reference to the drawings.

(Electrochromic Element)

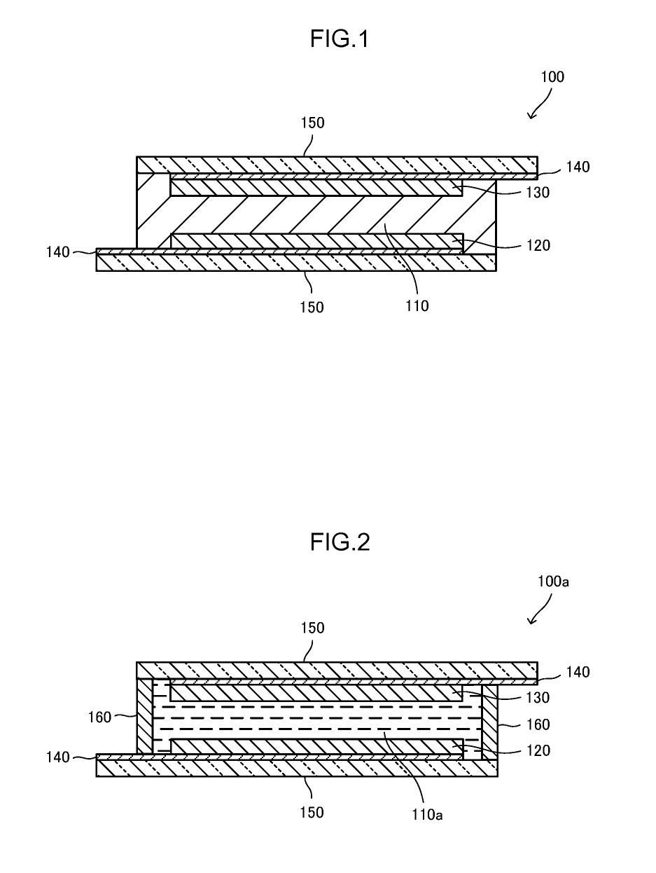

A cross-sectional view of an electrochromic element according to an embodiment of the present invention is illustrated in FIG. 1. An electrochromic element 100 illustrated in FIG. 1 includes: a transparent electrolyte layer 110, a pair of solid electrochromic layers (a reduction coloring-type solid electrochromic layer 120, an oxidation coloring-type solid electrochromic layer 130) sandwiching the transparent electrolyte layer 110, and further a pair of transparent conductive films 140 sandwiching the pair of solid electrochromic layers. The transparent conductive films 140 are supported by transparent support substrates 150.

<Transparent Electrolyte Layer>

The transparent electrolyte layer 110 enables to reversibly and simultaneously move ions (a cation such as H⁺, Li⁺, Na⁺, Ag⁺, or K⁺, or an OH⁻ type anion) involved in an electrochromic phenomenon to the electrochromic layers 120, 130 and is capable of blocking transfer of electrons, and formed of a transparent material.

A material which forms this transparent electrolyte layer 110 may be a material having the above-described functions and a relatively chemically and electrically stable material. Examples of such materials include an organic material, an inorganic material, and a composite material of the organic material and the inorganic material. These materials can be used in any form of a solid state, a gel state, or a liquid state.

Examples of electrolyte materials in the gel state include, for example, polymers which exhibit proton conduction such as hydrocarbon-based proton conducting polymers, their fluorine-substituted proton conducting polymers, and lithium-ion conducting polymers.

The electrolyte material in the gel state as stated above can be obtained by polymerizing, for example, (i) a eutectic mixture formed by containing a compound having an acid functional group and a basic functional group and ionizable salt, and (ii) an electrolyte precursor solution containing a monomer capable of forming a gel-state polymer by a polymerization reaction.

Here, (i) the eutectic mixture is used as an electrolyte component. In general, since the eutectic mixture does not have a vapor pressure, there is no problem of evaporation and depletion of the electrolyte, and the eutectic mixture is very stable and can prevent a side reaction in this electrochromic element. An Example of the eutectic mixture includes, for example, a eutectic mixture of an amide-based compound such as acetamide or urea and ionizable salt, and examples of a cation component which forms the ionizable salt preferably include tetraammonium, magnesium, sodium, potassium, lithium, calcium, or the like, and examples of an anion component preferably include thiocyanate, formate, acetate, nitrate, perchlorate, sulfate, hydroxide, alkoxide, halide, carbonate, oxalate, tetrafluoroborate, or the like.

The monomer which is contained in (ii) the electrolyte precursor solution is not particularly limited as long as the gel-state polymer can be formed by the polymerization reaction of the monomer, and various types of monomers are applicable. Examples of such monomers include, for example, acrylonitrile, methyl methacrylate, methyl acrylate, methacrylonitrile, methylstyrene, vinylesters, vinyl chloride, vinylidene chloride, acrylamide, tetrafluoroethylene, vinyl acetate, vinyl chloride, methyl vinyl ketone, ethylene, styrene, para-methoxystyrene, para-cyanostyrene, or the like.

Examples of such monomers further include, for example, a copolymer of β-hydroxyethyl methacrylate and 2-acrylamide-2-methylpropanesulfonic acid, a hydrated vinyl polymer such as a hydrated methyl methacrylate copolymer, hydrated polyester, a fluorine-based polymer, and the like. The examples also include an aromatic hydrocarbon-based polymer having a polyetherketone-based, polyphenylene sulfide-based, polyimide-based, or polybenzazole-based aromatic ring in its main chain skeleton and having a sulfonic acid group, and the like. Examples of the fluorine-based polymer concretely include, Flemion (registered trademark) (manufactured by ASAHI GLASS COMPANY, product name), Nafion (registered trademark) (manufactured by Du Pont, product name), Aciplex (registered trademark) (manufactured by Asahi Kasei Corporation, product name), and the like.

In a case of a lithium ion Li+ in the context of good ion conductivity, it is possible to be selected from a Li-containing or non-containing metal oxide, a mixture of the metal oxide, or the like, and there can be exemplified nickel oxide (NiO)ₓ (0<x≤1.5), nickel oxide containing lithium (LiₓNiO₂) (0≤x≤1), a mixture of titanium and cerium oxide (CeTiOₓ) (0<x≤4), tungsten oxide (WO₃), niobium oxide (Nb₂O₅), vanadium oxide (V₂O₅), vanadium oxide containing lithium (LiₓV₂O₅) (0<x≤2), and the like.

Such electrolyte materials can be used in any form of the solid state, the gel state, or the liquid state. Among them, forms in the liquid state and in the gel state are often preferably used in the context of increasing a moving speed of ions and response characteristics of color-development/reduction, and in the context of an easy application to sealing, and reliability.

Examples of an electrolyte in the liquid state include an aqueous electrolyte in which an ionic substance is dissolved in water or an organic electrolyte in which the ionic substance is dissolved in an organic solvent, but the organic electrolyte is preferred in the context of the reliability. Examples of ions moving in the electrolyte material applied to the organic electrolyte include Li⁺, Na⁺, K⁺, and the like, but Li ions having the highest electric conductivity are preferred in the context of the response speed.

A liquid-state Li-based electrolyte may be constituted of Li salt as a supporting electrolyte which is engaged in Li-ion implantation and a polar solvent which dissolves the salt, and a polymer which is soluble in the same solvent for viscosity adjustment or the like may be added as necessary. After a polymerizable compound is mixed in this electrolyte and the mixture is injected into an empty cell in an element in which a solid electrochromic layer has already been formed, or the like, the resultant may be cured by UV light, heat, or the like.

Examples of the Li salt include, for example, alkali metal salt such as LiClO₄, LiPF₆, LiTFSI (lithiumbistrifluoromethanesulfonimide), LiI, LiBF₄, CF₃SO₃Li, CF₃COOLi, and nonrestrictive examples of an electrolyte solvent include propylene carbonate, ethylene carbonate, acetonitrile, γ-butyrolactone, methoxypropionitrile, 3-ethoxypropionitrile, triethylene glycol dimethyl ether, sulfolane, dimethyl sulfoxide, dimethylformamide, or the like, or a mixture of these, and the like.

An ionic liquid which has been under active development in recent years or the like can also be applied as the polar solvent of the Li-based electrolyte. The ionic liquid is constituted of a cation site and a counter anion site, and examples of the cation site include an imidazolium-based cation, an alkylammonium-based cation, a pyridinium-based cation, a pyrrolidinium-based cation, a phosphonium-based cation, or the like. Examples of the counter anion site include halogen, AlCl₄⁻, PF₆⁻, TFSI⁻, or the like. Among them, there is known 1-ethyl-3-methylimidazolium bistrifluoromethanesulfonimide or the like in the context of ion-conductance, but it is not limited thereto.

The above-described electrolyte materials may further contain an additive having hydrophilicity which increases a degree of their hydration. Examples of such additives preferably include, for example, a metal such as W or Re, and an alkali metal of Li, Na, or K type can also be used. These additives exhibit the effect in an addition amount preferably corresponding to only a few percent by weight with respect to the material which forms the layer.

As described above, the material which is used for the transparent electrolyte layer 110 is preferably selected from a material which does not affect a material of the reduction coloring-type solid electrochromic layer 120 and a material of the oxidation coloring-type solid electrochromic layer 130 which are located on both sides, capable of adhering between both these layers, and is transparent.

<Solid Electrochromic Layer>

The solid electrochromic layer functions as a light-absorbing variable part capable of reversibly controlling color-development and color-reduction by applying a voltage. In the solid electrochromic layer, transmittance is high and transparency becomes high at the time of color-reduction, and the transmittance lowers and a light shielding property becomes high at the time of color-development.

The solid electrochromic layers may be provided such that different types of solid electrochromic materials from one another sandwich the transparent electrolyte layer 110, and one layer may be formed of a reduction coloring-type solid electrochromic material and the other layer may be formed of an oxidation coloring-type solid electrochromic material. In FIG. 1, the reduction coloring-type solid electrochromic layer 120 and the oxidation coloring-type solid electrochromic layer 130 constitute the light-absorbing variable part in the electrochromic element 100.

In this embodiment, the reduction coloring-type solid electrochromic layer 120 and oxidation coloring-type solid electrochromic layer 130 as described above are used in combination. It is thereby possible for light-absorbing properties of the electrochromic element 100 to exhibit properties where the color-development of the reduction coloring-type solid electrochromic layer 120 and the color-development of the oxidation coloring-type solid electrochromic layer 130 are combined, resulting in that a color tone closer to a neutral color is enabled rather than a case when one of the two types of solid electrochromic layers is used alone. Note that in this embodiment, light means visible light whose wavelength is in a range of 380 to 780 nm unless otherwise specified.

Examples of the reduction coloring-type solid electrochromic material include, for example, tungsten trioxide (WO₃) and molybdenum trioxide (MoO₃). These materials may be each used alone, or two or more types of the materials may be compounded to be used in order to change a color tone at the time of color-development. Making a composite oxide allows flattening of spectrum transmittance at the time of color-reduction, control of an absorption band at the time of color-development, and the like. Further, the reduction coloring-type solid electrochromic material may contain an additive such as TiO₂ for correcting a color tone in order to make the color tone close to a neutral color tone in a wide wavelength band. In this case, absorption in a visible light wavelength band of the reduction coloring-type solid electrochromic is approximated to be flat.

Examples of the oxidation coloring-type solid electrochromic material include, for example, oxide, hydroxide, or hydrated oxide each containing a metal selected from Ni, Ir, Cr, V, Mn, Cu, Co, Fe, W, Mo, Ti, Pr, and Hf. Moreover, the oxide, hydroxide, or hydrated oxide may be a composite oxide, a composite hydroxide, or a composite hydrated oxide with one kind or two or more kinds of elements selected from a group made up of Li, Ta, Sn, Mg, Ca, Sr, Ba, Al, Nb, Zr, In, Sb, and Si. Further, the oxidation coloring-type solid electrochromic material may be used as a dispersion which is obtained by dispersing in a dispersion medium of ITO, ZnO, MgF₂, CaF₂, or the like. The oxidation coloring-type solid electrochromic material to be used may be determined in consideration of the transmittance in an oxidation color-development state and a reduction color-reduction state, a wavelength dispersion state, and the like.

<Transparent Conductive Film>

The transparent conductive films 140 are a pair of members which further sandwiches the pair of solid electrochromic layers which sandwiches the above-described transparent electrolyte layer 110, and producing a potential difference between the pair of these transparent conductive films 140 makes it possible to apply a voltage between the transparent conductive films 140.

Examples of a material which forms this transparent conductive film 140 include, for example, a thin metal film of Ag, Cr, or the like, tin oxide, zinc oxide, tin oxide (SnO₂) where another oxide is doped with a small amount of component thereof, a metal oxide such as ITO, FTO, IZO, or indium oxide (In₂O₅), or a mixture of these. A forming method of a transparent conductive film is not particularly limited, but for example, a vacuum deposition method, an ion plating method, an electron beam vacuum deposition method, or a sputtering method can be used.

In the transparent conductive film 140, it is preferable that a sheet resistance value is as low as possible for reasons that too high sheet resistance causes loss of electricity necessary for the solid electrochromic layer, decrease of in-plane uniformity, decrease in a dynamic range of color-development/reduction, delay in a response time until states changes between the color-development and the color-reduction, or the like. Concretely, 100Ω/□ or less is preferred, 50Ω/□ or less is more preferred, and 10Ω/□ or less is further preferred though it depends on a size of the element. A thickness of the transparent conductive film 140 is preferably 0.01 to 0.5 μm in consideration of the visible light transmittance of the transparent conductive film.

<Transparent Support Substrate>

The electrochromic element usually has a transparent support substrate on a single surface or both surfaces, and FIG. 1 exemplifies a constitution where the transparent support substrates are provided on both surfaces. A shape of the electrochromic element 100 is retained stably by the transparent support substrates 150. The transparent support substrate 150 is not limited as long as it has transparency and predetermined strength, and for example, glass, ceramics, or resin can be used.

Here, examples of the glass include soda lime glass, borosilicate glass, alkali-free glass, quartz glass, and the like. There can be also cited glass having a light absorbing property where CuO or the like is added to fluorophosphate-based glass, phosphate-based glass, or the like, as infrared cut glass.

Examples of the resin include a thermoplastic resin such as polyethylene terephthalate, polyethylene naphthalate, polybutylene terephthalate, polycarbonate, or cycloolefin, and a thermosetting resin such as polyimide, polyetherimide, polyamide, or polyamide-imide. Moreover, when the resin is formed as an uneven molded body by imprinting or the like, an energy ray-curable resin such as acrylic or epoxy can be used.

A thickness of the transparent support substrate is not limited, but is preferably 0.01 to 1 mm, and more preferably 0.03 to 0.1 mm in the context of achieving reduction in weight and thinning and when the transparent support substrate is provided on only the single surface.

When the transparent support substrates are provided on both surfaces of the electrochromic element 100, a thickness of each transparent support substrate is preferably 0.01 to 0.1 mm, more preferably 0.01 to 0.03 mm, and further preferably 0.01 to 0.02 mm. Note that the thicknesses of the transparent support substrates on both surfaces are preferably the same because warps of the substrates or the like can be suppressed. Further, the electrochromic element which is sandwiched by these transparent support substrates on both surfaces may be used by sticking it on part of an element member of an applicable product in the context of mechanical strength. As described above, a material whose mechanical strength is strong and whose shielding ability against oxygen, moisture, or the like in the air, is high can be preferably used for the transparent support substrate.

<Physical Properties of Transparent Electrolyte Layer and Solid Electrochromic Layers>

Next, combinations regarding physical properties (refractive indexes and optical film thicknesses, in particular) between the transparent electrolyte layer 110 and the solid electrochromic layers in this embodiment are described.

Here, a thickness of the transparent electrolyte layer 110 is set as d0, a refractive index thereof with respect to light at a wavelength of 550 nm is set as n0, a thickness of the reduction coloring-type solid electrochromic layer 120 is set as d1, a refractive index thereof with respect to light at a wavelength of 550 nm is set as n1, a thickness of the oxidation coloring-type solid electrochromic layer 130 is set as d2, and a refractive index thereof with respect to light at a wavelength of 550 nm is set as n2. At this time, the refractive index n0 is selected to be different from either the refractive index n1 or n2. The refractive index n1 and the refractive index n2 may be the same or different.

First, the thickness d0 of the transparent electrolyte layer 110 can be appropriately determined according to properties of the electrochromic element 100. The thickness d0 of the transparent electrolyte layer 110 may be 5 μm or more, and preferably 6 μm or more so as to prevent optical interference between the pair of solid electrochromic layers with each other and to obtain stable optical characteristics. The thickness d0 may be 10 μm or less, preferably 9 μm or less, and more preferably 8 μm or less so as not to reduce the transmittance by increasing light absorption more than necessary, and to lower the response speed.

An absolute value of a difference between the refractive index n0 and the refractive index n1 (|n0−n1|) is preferably over 0.1, more preferably 0.2 or more, and further preferably 0.3 or more in the context of capable of enlarging flexibility of a material selection. An absolute value of a difference between the refractive index n0 and the refractive index n2 (|n0−n2|) is also preferably over 0.1, more preferably 0.2 or more, and further preferably 0.3 or more in the context of capable of enlarging flexibility of a material selection. Differences between these absolute values are preferably near values with each other, and for example, an absolute value of the difference between these absolute values (|n0−n1|−|n0−n2|) is preferably 0.2 or less.

The electrochromic element 100 may be designed such that undulations of a spectral transmission spectrum generated at a multilayer film including the upper and lower solid electrochromic layers with respect to incident light are canceled out. For example, when a maximum value is held at a wavelength λa around a wavelength of 550 nm in a spectral transmission spectrum due to interference of light at an incident time from the transparent support substrate side of a stack where “the transparent support substrate/the transparent conductive film/the oxidation coloring-type solid electrochromic layer/the transparent electrolyte layer” including the oxidation coloring-type solid electrochromic layer are stacked in this order, d1 and d2 are to be adjusted such that a minimum value is held at a wavelength λb around the wavelength of 550 nm in a spectral transmission spectrum due to interference of light at an incident time from the transparent electrolyte layer side of a stack where “the transparent electrolyte layer/the reduction coloring-type solid electrochromic layer/the transparent conductive film/the transparent support substrate” including the reduction coloring-type solid electrochromic layer are stacked in this order, and |λa−λb|≤50 nm. This value is more preferably 40 nm or less, and further preferably 30 nm or less.

At this time, the wavelength λa which is the maximum value around the wavelength of 550 nm is a wavelength which is the nearest to 550 nm among maximums appeared in the spectral transmission spectrum. Here, the wavelength λb which is combined is a minimum wavelength which is the nearest to 550 nm among minimums appeared in the spectral transmission spectrum.

In the spectral transmission spectrum of the example, d1 and d2 may be adjusted to have a relation where the former becomes the minimum value and the latter becomes the maximum value. In this case, the wavelengths are exchanged to be applied such that the wavelength to be the minimum value around the wavelength of 550 nm is set as λa, and the wavelength to be the maximum value is set as λb. That is, the wavelength having the maximum value or the minimum value in the stack including the reduction coloring-type solid electrochromic layer is set as λa, and the wavelength having the minimum value or the maximum value in the stack including the oxidation coloring-type solid electrochromic layer is set as λb.

In this embodiment, an optical film thickness (n1×d1) of the reduction coloring-type solid electrochromic layer 120 is set to be equal to (λ¼)×m1 (where λ1 is 550 nm, m1 is a positive real number). An optical film thickness (n2×d2) of the oxidation coloring-type solid electrochromic layer 130 is set to be equal to (λ¼)×m2 (where λ1 is 550 nm, m2 is a positive real number).

Here, m1 and m2 satisfying the above-stated relation are respectively expressed by using certain positive integer numbers M1 and M2 as M1−0.3≤m1 M1+0.3, M2−0.3≤m2≤M2+0.3, and M1 and M2 at this time satisfy a relation where a difference (M1−M2) becomes an odd number such as ±1, ±3, ±5, or ±7. When M1 and M2 satisfy the relation, ripples in a color-reduction state can be effectively suppressed. At this time, the difference between M1 and M2 is desirably smaller in the context of suppression of the ripples, and is preferably ±1. This is because the interference of the electrochromic layer in itself becomes the maximum (M is an even number) or the minimum (M is an odd number) at a corresponding wavelength λ when m=M. As stated above, the transmission spectrum from the multilayer film including the electrochromic layer becomes the maximum or the minimum at this wavelength, and the upper and lower interferences can be canceled out by setting these values as a combination of the maximum and the minimum.

Characteristics of the spectral transmission spectra of the reduction coloring-type solid electrochromic layer 120 and the oxidation coloring-type solid electrochromic layer 130 are shifted by satisfying the aforementioned relation, and thereby, the ripples in the color-reduction state of the electrochromic element 100 can be suppressed by balancing out the interferences when they are added up.

<Shielding Layer>

In this embodiment, a (non-illustrated) shielding layer may be formed at least one of a position between the reduction coloring-type solid electrochromic layer 120 and the transparent electrolyte layer 110 and a position between the oxidation coloring-type solid electrochromic layer 130 and the transparent electrolyte layer 110. The shielding layer is formed of a transparent material which does not obstruct movement of ions between the respective layers and may be formed by a chemically inactive material with the transparent electrolyte layer 110, the reduction coloring-type solid electrochromic layer 120, and the oxidation coloring-type solid electrochromic layer 130.

There is a possibility that the reduction coloring-type solid electrochromic layer 120 is altered and deteriorated due to moisture derived from proton conducting ions of the transparent electrolyte layer 110 or the oxidation coloring-type solid electrochromic layer is altered and deteriorated due to acidity. Hence, metal ions are sometimes gradually eluted from the electrochromic layers by, in particular, acidic hydrated ions or the like held by an acidic group such as a sulfonic acid group or a carboxylic acid group, and the like. However, forming this shielding layer between the respective layers makes it possible to suppress such trouble.

In other words, providing this shielding layer makes it possible to stably drive the respective layers over a long period and improve reliability of the electrochromic element without direct contact of the transparent electrolyte layer 110 with the reduction coloring-type solid electrochromic layer 120 and/or the oxidation coloring-type solid electrochromic layer 130.

When the electrochromic element of this embodiment includes the shielding layer, for example, when the maximum value is held at the wavelength λa around the wavelength of 550 nm in a spectral transmission spectrum due to interference of light at an incident time from the transparent support substrate side of a stack where “the transparent support substrate/the transparent conductive film/the oxidation coloring-type solid electrochromic layer/the shielding layer/the transparent electrolyte layer” including the oxidation coloring-type solid electrochromic layer are stacked in this order, d1 and d2 are to be adjusted such that the minimum value is held at the wavelength λb around the wavelength of 550 nm in a spectral transmission spectrum due to interference of light at an incident time from the transparent electrolyte layer side of a stack where “the transparent electrolyte layer/the shielding layer/the reduction coloring-type solid electrochromic layer/the transparent conductive film/the transparent support substrate” including the reduction coloring-type solid electrochromic layer are stacked in this order, and |λa−λb|≤50 nm. Even when the shielding layer is included, the optical film thickness (n1×d1) of the reduction coloring-type solid electrochromic layer 120 is set to be equal to (λ¼)×m1, and the optical film thickness (n2×d2) of the oxidation coloring-type solid electrochromic layer 130 is set to be equal to (λ¼)×m2.

Note that presence/absence of the “shielding layer” which is optionally included is set aside in the expressions of “the transparent support substrate/the transparent conductive film/the oxidation coloring-type solid electrochromic layer/the transparent electrolyte layer” and “the transparent electrolyte layer/the reduction coloring-type solid electrochromic layer/the transparent conductive film/the transparent support substrate”, and when the “shielding layer” is apparently included, the stack is expressed such that “the transparent support substrate/the transparent conductive film/the oxidation coloring-type solid electrochromic layer/the shielding layer/the transparent electrolyte layer” to include the “shielding layer”.

A film other than the shielding layer may further be additionally provided. In this case, the wavelengths λa, λb may be determined through a similar method in consideration of the added film in the above-stated stacks.

When the shielding layer is provided at either one of the stacks, the improvement in reliability is likely to be obtained by disposing the shielding layer in the stack on the oxidation coloring-type solid electrochromic layer 130 side which is relatively inferior in stability, that is, between the oxidation coloring-type solid electrochromic layer 130 and the transparent electrolyte layer 110. The shielding layers are preferably provided in both stacks to further improve the reliability of the electrochromic element. Various oxides and nitrides can be used as a material forming the shielding layer.

(Optical Characteristics)

Hereinafter, optical characteristics of the electrochromic element 100 will be described. First, V=V1 is applied as a voltage V so that the reduction coloring-type solid electrochromic layer 120 has a negative polarity and the oxidation coloring-type solid electrochromic layer 130 has a positive polarity, and both of the solid electrochromic layers become in color-development states and become in states of shielding visible light in an entire drive area region of this electrochromic element. Note that later-described (both) terminals correspond to the pair of transparent conductive films 140.

Here, V=V2 (where |V2|<|V1|) is applied as the voltage V between both terminals of the reduction coloring-type solid electrochromic layer 120 and the oxidation coloring-type solid electrochromic layer 130, resulting in that the color-development states of both of the solid electrochromic layers become a trend to reduce color. At this time, the color-reduction trend proceeds as an absolute value of the voltage becomes small.

Besides, V=V3 is applied as the voltage V so that the voltage between the terminals becomes a reversed polarity, that is, the reduction coloring-type solid electrochromic layer 120 has the positive polarity and the oxidation coloring-type solid electrochromic layer 130 has the negative polarity, resulting in that both of the solid electrochromic layers are completely in the color-reduction states, and become in states of transmitting visible light in the entire drive area region of this electrochromic element.

In this electrochromic element, a maximum value of the applied voltage V is set at as high voltage as possible in a range not exceeding an overvoltage so as not to impair stability of this element due to a side reaction, which allows to variably reach a stronger color-development/reduction state faster. An actual maximum applied voltage may be selected according to properties required for the electrochromic element, but it can be preferably controlled generally within ±3 V, preferably within ±2 V, and more preferably within ±1.5 V so that the stability of the electrochromic element and fast variability can be obtained.

In this electrochromic element, when the color-development state being the state of shielding visible light in the entire drive area region of this element, the color-reduction state being the state of transmitting visible light in the entire drive area region of this element, and an intermediate state therebetween are controlled by a voltage (V) from outside, the thickness d1 of the reduction coloring-type solid electrochromic layer 120 and the thickness d2 of the oxidation coloring-type solid electrochromic layer 130 are preferably set in consideration of an optical density (an OD value) necessary for this element, too. The thicker these thicknesses are, the higher a light shielding performance becomes, meanwhile, there is a possibility that the stability of the electrochromic element is impaired and the response characteristics for a light intensity change becomes slow as described above because a required electric charge amount increases and a required voltage (V) becomes high.

Here, the optical density at a wavelength λ (nm) (the OD value (OD (λ)) is defined as follows.

OD(λ)=Log₁₀{PI(λ)/PT(λ)}=−Log₁₀T(λ)

Here, λ represents a specific wavelength, PI (λ) represents incident light intensity (at the wavelength λ), and PT (λ) represents transmitted light intensity (at the wavelength λ), and T represents transmittance, and the larger the OD value is, the larger an attenuation factor becomes. Here, an appropriate value in a visible range can be selected as a wavelength evaluating the transmittance, but since 632 nm is a wavelength of an He—Ne laser which can be easily obtained, and a wavelength corresponding to red among tristimulus values of a sensitivity of human eyes, this wavelength of 632 nm is often used.

In this embodiment, both of the reduction coloring-type solid electrochromic layer and the oxidation coloring-type solid electrochromic layer complementary develop color through the transparent electrolyte layer due to the voltage application. Accordingly, it is preferred because wavelength dispersion of visible light transmittance can be approximated to be flat in any of a color-reduction transmitting state where the transmittance at the wavelength of 632 nm becomes 80% or more, an intermediate transmitting state where the transmittance becomes approximately 50%, and a color-development transmitting state where the transmittance becomes 10% or less compared to a system where the solid electrochromic layer independently develops/reduces color.

At this time, average transmittance with respect to light at a wavelength of 380 to 780 nm is preferably 75% or more, more preferably 80% or more, and further preferably 85% or more in the color-reduction state of the electrochromic element.

The electrochromic element 100 obtained as stated above preferably has more uniform visible light transmittance. There are several evaluation methods to evaluate the uniformity. For example, there can be cited deviation (standard deviation, average deviation, variation ratio, and so on) of transmittance in a visible range satisfies a predetermined range, a difference of transmittances at specific wavelengths (for example, transmittances at respective wavelengths of RGB) satisfies a predetermined range, and so on.

An example of the standard deviation includes, for example, a standard deviation found from transmittances obtained by sequentially measuring spectral transmittances from a short wavelength side to a long wavelength side at an arbitrary wavelength width while setting the number of samplings of the transmittance with respect to the light at the wavelength of 380 to 780 nm including the visible range as N. The measurement is preferably performed while setting the wavelength width within a range of 380 to 780 nm and with a wavelength interval of 10 nm or less to find the standard deviation, in the context of reliability of the obtained standard deviation, avoiding complication due to increase in the number of measurements, and so on.

Here, an average value Tₘ, a standard deviation a, a variation coefficient T_{cv} of a spectral transmittance spectrum can be found from the transmittance obtained by the measurement through the following expressions (1) to (3).

$$[ Mathematical expression 1 ]$$

$$\begin{matrix}{T}_{m} = \frac{1}{N} {\sum }_{i = 1}^{N} {x}_{i} \\ [ Mathematical expression 2 ] & ( 1 ) \\ σ = \sqrt{\frac{1}{N} {\sum }_{i = 1}^{N} {( {x}_{i} - {T}_{m} )}^{2}} \\ [ Mathematical expression 3 ] & ( 2 ) \\ {T}_{cv} = \frac{σ}{{T}_{m}} & ( 3 )\end{matrix}$$

(In each expression, N is the number of samplings, xᵢ is transmittance in measurement at the i-th measurement order from a lower wavelength side.)

The standard deviation and the variation ratio obtained as stated above are preferred as each numeric value is smaller because deviation from an average value of the transmittance is small.

When transmittance at a specific wavelength (for example, the transmittances at respective wavelengths of RGB) is considered, a color tone does not incline toward a specific color, and is balanced if a difference in the transmittances at the respective wavelengths is small. The transmittances at the respective wavelengths are therefore desirably within a predetermined range. For example, at the time of color-reduction, the transmittances at the respective wavelengths of RGB are each desirably within a range of ±10% with respect to an average value of the transmittances at the wavelengths corresponding to RGB. Concretely, for example, when transmittance with respect to light at a wavelength of 400 nm is set as T₄₀₀, transmittance with respect to light at a wavelength of 530 nm is set as T₅₃₀, and transmittance with respect to light at a wavelength of 630 nm is set as T₆₃₀, a value of the transmittance with respect to each of the three wavelengths is preferably within ±10%, more preferably within ±8%, and further preferably within ±5% with respect to an average value of these transmittances.

According to this embodiment, the electrochromic element capable of reversibly controlling transmittance of the electrochromic element in response to an applied voltage can be obtained. This control of the transmittance can be enabled by reversibly changing and controlling color-development/reduction (absorption amount of light) in both layers of the reduction coloring-type solid electrochromic layer and the oxidation coloring-type solid electrochromic layer by applying a voltage between both of the transparent conductive films.

In the aforementioned embodiment, the reduction coloring-type solid electrochromic layer and the oxidation coloring-type solid electrochromic layer are made to exist oppositely to each other in an electrochromic element system, in the context of capable of setting a variable range of transmittance large, and enabling a neutral color tone widely across a visible range.

In the electrochromic element 100 of this embodiment, ripples in the color-reduction state can be suppressed and a good transmission color can be obtained by making the thicknesses and optical film thicknesses of the transparent electrolyte layer 110, the reduction coloring-type solid electrochromic layer 120 and the oxidation coloring-type solid electrochromic layer 130 satisfy predetermined relations.

(Manufacturing Method of Electrochromic Element)

In the electrochromic element of this embodiment, the stacked reduction coloring-type solid electrochromic layer and oxidation coloring-type solid electrochromic layer, and the transparent electrolyte layer and the shielding layer which are located between the layers, may be formed by dry film formation such as sputtering, vacuum deposition, ion plating, or pulse laser deposition, or a sol-gel based material may be cured after wet film formation, regardless of the above-exemplified embodiment. Both of these dry film formation and wet film formation may be fitly mixed. Direct film formation on a stacking object is possible when a material is an oxide or a composite oxide, and after the film formation, the material can also be formed into an oxide by anodic oxidation in, for example, an electrolytic solution, and reactive sputtering can also be performed for a metal target under an oxygen environment to obtain these layers.

Film formation of the reduction coloring-type solid electrochromic layer, the oxidation coloring-type solid electrochromic layer, and the transparent electrolyte layer and the shielding layer which are located between the solid electrochromic layers on the transparent support substrates may be performed by sequential stacking on a single surface of the transparent support substrate, or the reduction coloring-type solid electrochromic layer and the oxidation coloring-type solid electrochromic layer may be film-formed separately on the respective transparent support substrates, and thereafter they may be combined in close contact with each other with the transparent electrolyte (layer) interposed therebetween.

This electrochromic element may be obtained by separately film-forming the reduction coloring-type solid electrochromic layer and the oxidation coloring-type solid electrochromic layer on the respective transparent electrode-attached transparent support substrates on both sides thereof, and thereafter forming an empty cell with a seal interposed therebetween, and injecting a liquid-state transparent electrolyte under reduced pressure, instead of the manufacturing method of combining the layers in close contact with each other with the transparent electrolyte (layer) interposed therebetween. In this case, since it is not necessary to combine the layers in close contact with each other with the above-described solid-based or semisolid-based transparent electrolyte interposed therebetween, there is no concern for deterioration due to leakage or the like even if the liquid-state electrolyte is used, and the electrochromic element with high reliability can be produced by previously forming the empty cell with high hermeticity.

Here, the liquid-state transparent electrolyte which is injected under the reduced pressure is preferably the organic electrolyte in the context of the reliability and further preferably the Li-based electrolyte whose ion conductivity is high in the context of the response speed, as described above.

An electrochromic element 100a obtained by using the liquid-state electrolyte is formed by including a liquid-state transparent electrolyte layer 110a, the pair of solid electrochromic layers (the reduction coloring-type solid electrochromic layer 120, the oxidation coloring-type solid electrochromic layer 130) sandwiching the transparent electrolyte layer 110a, and further the pair of transparent conductive films 140 sandwiching the pair of solid electrochromic layers, as illustrated in FIG. 2. The transparent conductive films 140 are supported by the transparent support substrates 150. Here, when the electrolyte is liquid, wall materials 160 are provided on four sides between the transparent support substrates 150 to form a cell so that the electrolyte can be kept inside thereof. Here, the electrochromic element 100a illustrated in FIG. 2 is different from the electrochromic element 100 in FIG. 1 only in a point that the liquid-state transparent electrolyte is used as the transparent electrolyte, and accordingly, the wall materials 160 are provided so as to keep the liquid-state transparent electrolyte inside thereof, and other constitutions are the same.

This electrochromic element may include a protective film in order to block oxygen and moisture in the air to drive this element stably over a long period. For example, a required amount of an adhesive may be applied so as to cover an upper surface and a side surface (on a side opposite to the transparent support substrate) of this electrochromic element having a constitution in which the layers are stacked on one transparent support substrate and this electrochromic element may be adhered to another optical member to be sealed.

In this electrochromic element 100 having a constitution in which the layers are sandwiched between the two transparent support substrates 150, an adhesive containing a spacer as necessary is applied so as to cover a peripheral part of this element in the support substrates, to be sealed.

As a sealing material which is used here, a publicly known thermosetting or photo-curing adhesive can be used alone or in combination. Concretely, there can also be used a polymerizable compound such as an epoxy-based adhesive which causes a ring-opening reaction in addition to adhesives which have a functional group having a carbon-carbon unsaturated double bond such as a silicone-based adhesive, an acrylic-based adhesive, and an enethiol-based adhesive. Since polymerization shrinkage is small in such compounds, not only precision formation by using a forming die is allowed, but also it is possible to reduce a warp. The sealing material is more preferred if a polyfunctional compound having two or more functions is contained.

When this electrochromic element including the transparent support substrate is produced, a reinforcing support substrate having a thickness larger than that of the transparent support substrate may be temporarily attached in order to reinforce the transparent support substrate. When the reinforcing support substrate is used, the electrochromic element having a thin total thickness can be obtained by peeling the temporarily attached reinforcing support substrate after stacking two transparent support substrates on which the respective solid electrochromic layers are film-formed, or previously forming the empty cell. For the temporary attachment, a publicly known resin and the like capable of peeling or the like later and adhering temporarily can be used.

In a process film-forming each solid electrochromic layer on a reinforcing support substrate-attached transparent support substrate, when a film-formation temperature and a subsequent firing temperature, and further a seal curing temperature when the empty cell is formed by opposing the substrates on which the respective solid electrochromic layers are film-formed, and the like require high temperatures of, for example, about 150 to 350° C., there is a possibility that peel strength between the transparent support substrate and the resin or the like which is used for temporarily attaching changes. Accordingly, the resin or the like which is used for the temporary attachment may be selected so that a fixing position of the reinforcing support substrate and the transparent support substrate does not deviate from each other in a case of exposure to such a high-temperature condition in the process or so that the transparent support substrate is not damaged in peeling after too strong fixing.

Concretely, examples of the resin used for the temporary attachment include an acrylic resin, a urethane resin, a silicone resin, or the like, and the silicone resin excellent in heat resistance, temporary attachment strength, and removability is preferred. (Reference: International Publication Pamphlet No. 2014-103678)

The desired electrochromic element whose total thickness is thin may be obtained by after previously preparing the transparent support substrate having a thickness capable of maintaining mechanical strength, and completing the electrochromic element, subjecting the transparent support substrates on both sides to slimming by physical polishing or chemical polishing (etching).

Concretely, in consideration of the total thickness of this electrochromic element, a thickness of each of the transparent support substrates to be used is set to 0.5 to 0.7 mm, and slimming treatment may be performed to a range of 0.01 to 0.03 mm, further as necessary, to a range of 0.01 to 0.02 mm as the thickness of each of the transparent support substrates which constitutes this element. When the thickness of the transparent support substrate before the slimming treatment is 0.5 to 0.7 mm, the respective support substrates on which the respective electrochromic layers are stacked are opposed, and the empty cell can be previously produced and further as necessary, outer peripheral parts of the opposed transparent support substrates are subjected to outer peripheral sealing and thereafter the liquid-state electrolyte can be injected stably in the empty cell. Then, after injecting the liquid-state electrolyte in the empty cell and sealing an injection hole, both surfaces may be subjected to the slimming treatment simultaneously until a desired electrochromic element thickness of, for example, 0.06 mm or less.

In a case of the slimming by the chemical polishing (etching), an etching solution containing a hydrofluoric acid is general, but when the transparent support substrate is alkali-free glass, or the like, etching solution composition may be selected as necessary. (Reference: Japanese Patent Publication No. 5423874)

The electrochromic element described hereinabove can be applied to an ND filter or the like.

When this element is used as an ND filter for an imaging device, light intensity can be adjusted without lowering a gain of an imaging sensor by incorporating this element into the imaging sensor in the imaging device such as a camera. As the imaging device using this element, this element may be incorporated in an imaging optical system, or in an imaging device main body.

When the electrochromic element is incorporated in the imaging optical system, the electrochromic element may be used at any of a position between a subject and the imaging optical system, between the imaging optical system and the imaging sensor, and between lenses forming the imaging optical system. In this case, there is exemplified a case when the electrochromic element is driven by a signal from a driving circuit held by the main body.

### EXAMPLES

The electrochromic element of this invention is described in detail based on examples.

### Example 1

Optical characteristics of the electrochromic element illustrated in FIG. 1 were examined as follows by using transmission simulation software (here, software corresponding to Essential Macleod manufactured in-house by Thin Film Center Inc.).

First, spectral characteristics were calculated regarding the electrochromic element constituted by Flemion (registered trademark) (refractive index: 1.46, thickness: 8000 nm) as the transparent electrolyte layer, WO₃ (refractive index: n1=1.92) as the reduction coloring-type solid electrochromic layer, NiO (refractive index: n2=1.82) as the oxidation coloring-type solid electrochromic layer, an ITO electrode (refractive index: 1.76, thickness: 150 nm) as the transparent electrode, and an anti-reflection film-attached soda lime glass substrate (refractive index: 1.53, thickness: 0.1 mm) as the transparent support substrate.

A refractive index and an extinction coefficient which were found using Cauchy model from spectral transmittance and spectral reflectance of soda lime float glass manufactured by ASAHI GLASS COMPANY were used regarding the glass substrate, and a value where wavelength dependency of a refractive index and an extinction coefficient were found using Cauchy model from transmittance and reflectance which were spectroscopically measured from a Flemion layer formed on the same glass was used regarding the Flemion layer. Wavelength dependency of a refractive index and an extinction coefficient calculated based on Drude model from comparison with spectral characteristics was also used regarding the ITO. Derivation of optical constants by fitting with the spectral characteristics using these models was performed by WVASE32 software attached to a spectral ellipsometer manufactured by J. A. Woollam Co., Inc.

The film thicknesses of the reduction coloring-type solid electrochromic layer and the oxidation coloring-type solid electrochromic layer were changed such that the optical film thicknesses satisfy a predetermined relation while assuming that an extinction coefficient at the time of color-reduction is zero (that is, a completely transparent material) and wavelength dependency of a refractive index does not exist. The calculation is performed while assuming that upper and lower media have the same refractive indexes as these glasses in order to eliminate reflection at outside interfaces of the glass substrates on both sides. Though many assumptions are included, it is considered that there is no problem in these assumptions to verify effects of the present invention.

In this example, when light at the wavelength of 550 nm (λ1=550 nm) was used, the thickness d1 of the reduction coloring-type solid electrochromic layer was fixed as follows such that the relation of (n1×d1)=(λ¼)×m1 was satisfied. That is, d1 (d1=644 nm) was set so that m1=9 (at this time, M1 is 9).

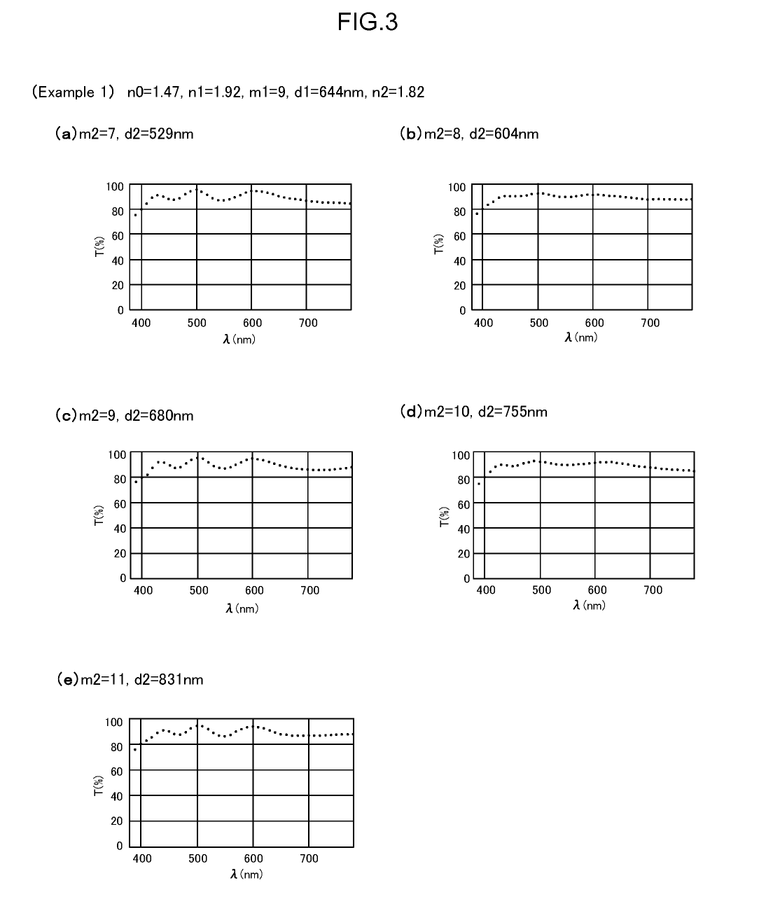

Next, when light at the wavelength of 550 nm (λ1=550 nm) was used, the thickness d2 of the oxidation coloring-type solid electrochromic layer was changed as follows such that the relation of (n2×d2)=(λ¼)×m2 was satisfied. That is, d2 was set such that m2 became 7, 8, 9, 10, 11 (M2 is 7, 8, 9, 10, 11), to calculate respective optical spectra. Data of the obtained optical spectra were illustrated in FIG. 3. The average value, the standard deviation, and the variation ratio of the transmittance at this time were listed in Table 1. In FIG. 3 and Table 1, the transmittances were illustrated from 380 nm to 780 nm every wavelength width of 10 nm (N=41). The standard deviation was calculated based on the transmittance obtained as stated above based on the aforementioned expression (1).

It was verified from FIG. 3 and Table 1 that appearance of ripples in a color-reduction state was effectively suppressed when M2 was M1−1=8, M1+1=10 where M7 was changed with respect to M1=9.

TABLE 1
n0 = 1.47, n1 = 1.92, d1 = 644 nm (m1 = 9), n2 = 1.82

| | | | | | Variation |
|---|---|---|---|---|---|
| m2 | | Average | Dispersion | Standard | ratio |
| (M2) | d2 (nm) | value Tm (%) | σ² | deviation σ | T_{CV} |
| 7 | 529 | 88.7023415 | 26.2142935 | 5.1199896 | 0.0577210 |
| 8 | 604 | 89.0670488 | 17.7793040 | 4.2165512 | 0.0473413 |
| 9 | 680 | 88.7955610 | 24.1198874 | 4.9112002 | 0.0553091 |
| 10 | 755 | 88.7611951 | 21.0379527 | 4.5867148 | 0.0516748 |
| 11 | 831 | 89.0235837 | 22.9092843 | 4.7863644 | 0.0537651 |

### Example 2

Example 2 used the electrochromic element which was different from Example 1 only in a point that NiO with a refractive index (n2) of 1.92 was used as the oxidation coloring-type solid electrochromic layer, and optical characteristics were similarly examined. Regarding the refractive index of NiO, a density of a formed film changes depending on film-forming conditions or the like, and the refractive index also changes depending thereon. Accordingly, though element configurations of the material (chemical composition) were the same as Example 1, only the refractive index of NiO was different in this example.

In this example, when light at the wavelength of 550 nm (κ1=550 nm) was used, the thickness d1 of the reduction coloring-type solid electrochromic layer was fixed such that the relation of (n1×d1)=(λ¼)×m1 was satisfied. At this time, d1 was set (d1=644 nm) such that m1=9 (at this time, M1 is 9).

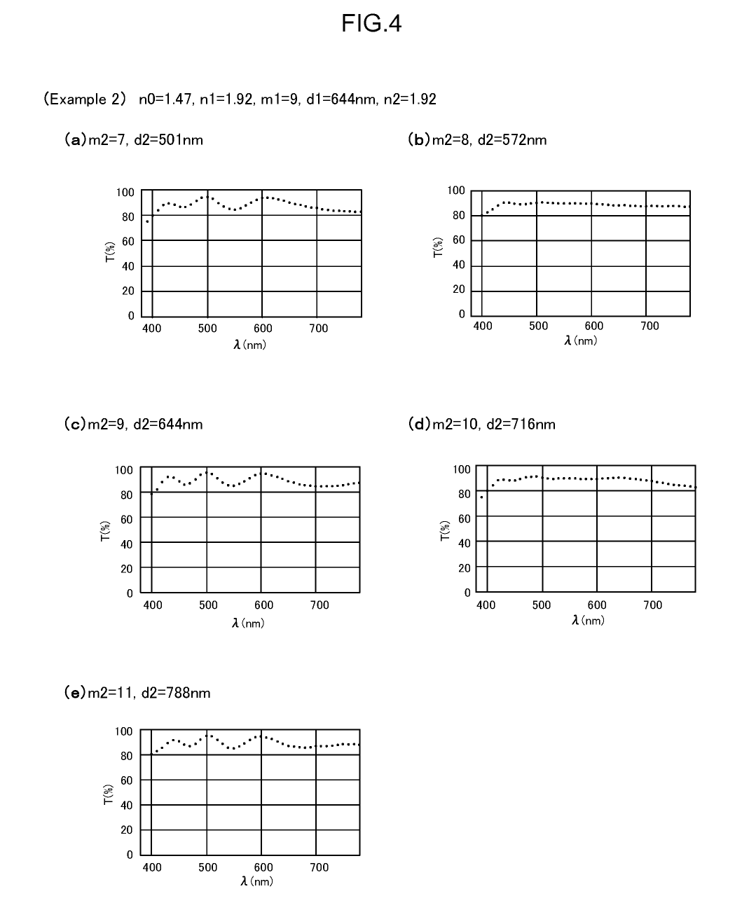

Next, when light at the wavelength of 550 nm (λ1=550 nm) was used, the thickness d2 of the oxidation coloring-type solid electrochromic layer was changed such that the relation of (n2×d2)=(λ¼)×m2 was satisfied. At this time, respective optical spectra were calculated when d2 was set such that m2 became 7, 8, 9, 10, 11 (where M2 was 7, 8, 9, 10, 11). Data of the obtained optical spectra were illustrated in FIG. 4. The average value and the standard deviation of the transmittance at this time were listed in Table 2. In FIG. 4 and Table 2, the transmittances were illustrated from 380 nm to 780 nm every wavelength width of 10 nm.

It was verified from FIG. 4 and Table 2 that appearance of ripples in the color-reduction state was effectively suppressed when M2=M1−1=8, M1+1=10 where M2 was changed with respect to M1=9.

TABLE 2
n0 = 1.47, n1 = 1.92, d1 = 644 nm (m1 = 9), n2 = 1.92

| | | | | | Variation |
|---|---|---|---|---|---|
| m2 | | Average | Dispersion | Standard | ratio |
| (M2) | d2 (nm) | value Tm (%) | σ² | deviation σ | T_{CV} |
| 7 | 501 | 87.8461707 | 27.2937190 | 5.2243391 | 0.0594714 |
| 8 | 572 | 88.3714634 | 15.4407793 | 3.9294757 | 0.0444654 |
| 9 | 644 | 87.9545610 | 25.1214451 | 5.0121298 | 0.0569854 |
| 10 | 716 | 87.9357317 | 19.3061314 | 4.3938743 | 0.0499669 |
| 11 | 788 | 88.3151707 | 23.1855511 | 4.8151377 | 0.0545222 |

### Example 3

Example 3 used the electrochromic element which was different from Example 1 only a point that a 1 mol/L LiTFSI (lithiumbistrifluoromethanesulfonylimide) propylene carbonate solution was used as the electrolyte layer, and optical characteristics were similarly examined. The refractive index of this electrolyte was regarded to be equal to propylene carbonate being a solvent, and calculated as 1.42.

In this example, when light at the wavelength of 550 nm (λ1=550 nm) was used, the thickness d1 of the reduction coloring-type solid electrochromic layer was fixed such that the relation of (n1×d1)=(λ¼)×m1 was satisfied. At this time, d1 was set (d1=644 nm) such that m1=9 (at this time, M1 is 9).

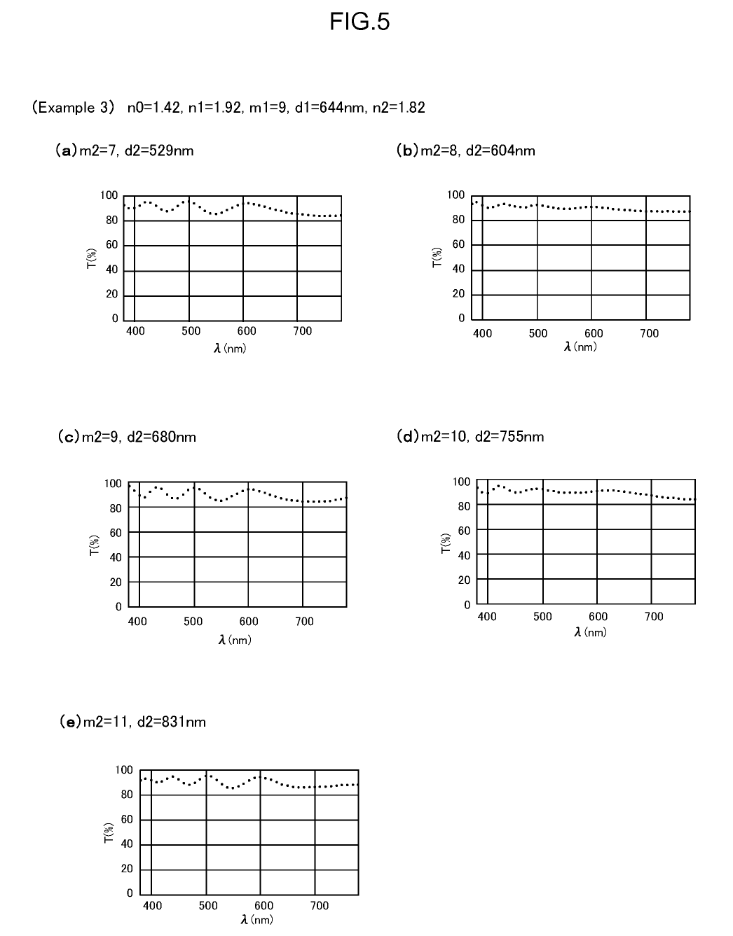

Next, when light at the wavelength of 550 nm (λ1=550 nm) was used, the thickness d2 of the oxidation coloring-type solid electrochromic layer was changed such that the relation of (n2×d2)=(λ¼)×m2 was satisfied. At this time, respective optical spectra were calculated when d2 was set such that m2 became 7, 8, 9, 10, 11 (where M2 was 7, 8, 9, 10, 11). Data of the obtained optical spectra were illustrated in FIG. 5. The average value and the standard deviation of the transmittances at this time were listed in Table 3. In FIG. 5 and Table 3, the transmittances were illustrated from 380 nm to 780 nm every wavelength width of 10 nm.

It was verified from FIG. 5 and Table 3 that appearance of ripples in the color-reduction state was effectively suppressed when M2 was M1−1=8, M1+1=10 where M2 was changed with respect to M1=9.

TABLE 3
n0 = 1.42, n1 = 1.92, d1 = 644 nm (m1 = 9), n2 = 1.82

| | | | | | Variation |
|---|---|---|---|---|---|
| m2 | | Average | Dispersion | Standard | ratio |
| (M2) | d2 (nm) | value Tm (%) | σ² | deviation σ | T_{CV} |
| 7 | 529 | 90.0675610 | 13.8126064 | 3.7165315 | 0.0412638 |
| 8 | 604 | 90.5328537 | 4.1099773 | 2.0273079 | 0.0223931 |
| 9 | 680 | 90.2424146 | 14.5716694 | 3.8172856 | 0.0423003 |
| 10 | 755 | 90.1394146 | 7.4540445 | 2.7302096 | 0.0302887 |
| 11 | 831 | 90.4538537 | 9.0080082 | 3.0013344 | 0.0331808 |

### Example 4

Example 4 used the electrochromic element which was different from Example 3 only a point that NiO with a refractive index (n2) of 1.92 was used as the oxidation coloring-type solid electrochromic layer, and optical characteristics were similarly examined. Regarding the refractive index of NiO, a density of a formed film changes depending on film-forming conditions or the like, and the refractive index also changes depending thereon. Accordingly, though element configurations of the material (chemical composition) were the same as Example 3, only the refractive index of NiO was different in this example.

In this example, when light at the wavelength of 550 nm (λ1=550 nm) was used, the thickness d1 of the reduction coloring-type solid electrochromic layer was fixed such that the relation of (n1×d1)=(λ¼)×m1 is satisfied. At this time, d1 was set (d1=644 nm) such that m1=9 (at this time, M1 is 9).

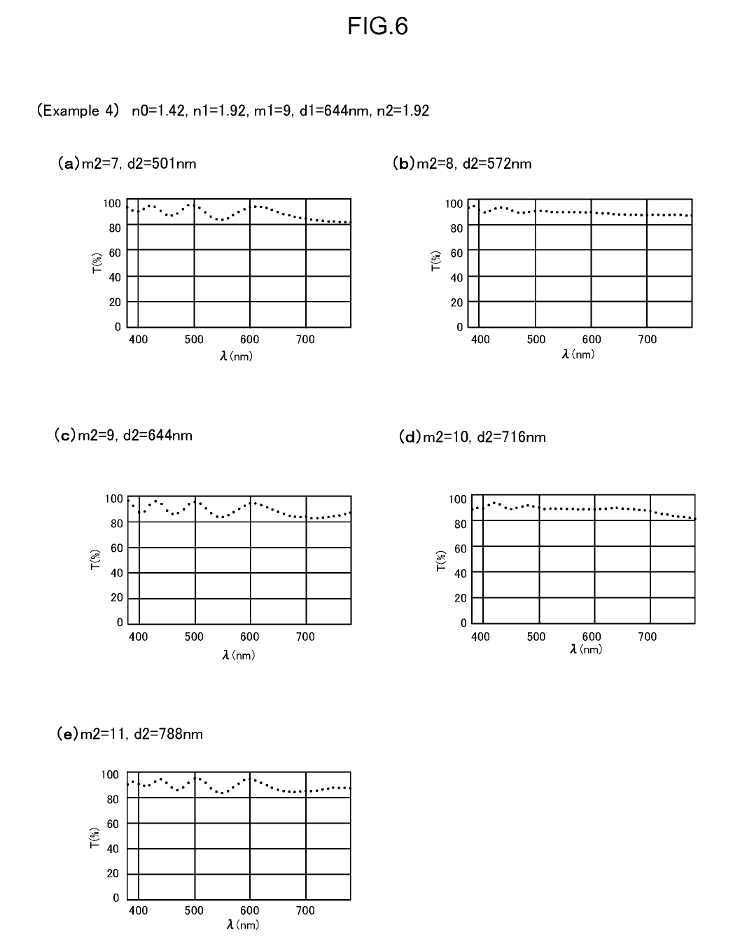

Next, when light at the wavelength of 550 nm (λ1=550 nm) was used, the thickness d2 of the oxidation coloring-type solid electrochromic layer was changed so that the relation of (n2×d2)=(λ¼)×m2 was satisfied. At this time, respective optical spectra were calculated when d2 was set such that m2 became 7, 8, 9, 10, 11 (where M2 was 7, 8, 9, 10, 11). Data of the obtained optical spectra were illustrated in FIG. 6. The average value and the standard deviation of the transmittance at this time were listed in Table 4. In FIG. 6 and Table 4, the transmittances were illustrated from 380 nm to 780 nm every wavelength width of 10 nm.

It was verified from FIG. 6 and Table 4 that appearance of ripples in the color-reduction state was effectively suppressed when M2 was M1−1=8, M1+1=10 where M2 was changed with respect to M1=9.

TABLE 4
n0 = 1.42, n1 = 1.92, d1 = 644 nm (m1 = 9), n2 = 1.92

| | | | | | Variation |
|---|---|---|---|---|---|
| m2 | | Average | Dispersion | Standard | ratio |
| (M2) | d2 (nm) | value Tm (%) | σ² | deviation σ | T_{CV} |
| 7 | 501 | 89.1262927 | 18.0428092 | 4.2476828 | 0.0476591 |
| 8 | 572 | 89.7462927 | 4.0120226 | 2.0030034 | 0.0223185 |
| 9 | 644 | 89.3051707 | 18.8807535 | 4.3451989 | 0.0486556 |
| 10 | 716 | 89.2255854 | 8.3405844 | 2.8880070 | 0.0323675 |
| 11 | 788 | 89.6644390 | 11.9672802 | 3.4593757 | 0.0385814 |

### Example 5

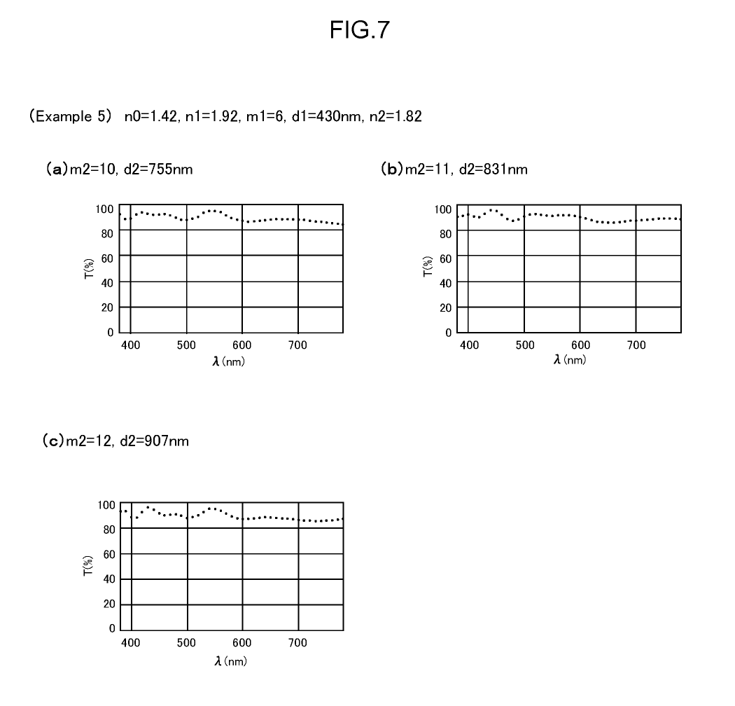

Respective optical spectra were calculated when d1 was set (d1=430 nm) such that m1=6 (at this time, M1=6), and m2 was set to 10, 11, 12 (where M2 was 10, 11, 12) in the constitution of Example 3. Data of the obtained optical spectra were illustrated in FIG. 7. Values calculated regarding the average value and the standard deviation of the transmittance at this time were listed in Table 5. In FIG. 7 and Table 5, the transmittance employs values from 380 nm to 780 nm every 10 nm.

TABLE 5
n0 = 1.42, n1 = 1.92, d1 = 430 nm (m1 = 6), n2 = 1.82

| | | | | | Variation |
|---|---|---|---|---|---|
| m2 | | Average | Dispersion | Standard | ratio |
| (M2) | d2 (nm) | value Tm (%) | σ² | deviation σ | T_{CV} |
| 10 | 529 | 90.1984634 | 7.8394971 | 2.7999102 | 0.0310417 |
| 11 | 604 | 90.4797073 | 6.0824228 | 2.4662568 | 0.0272576 |
| 12 | 680 | 90.2120244 | 8.5289816 | 2.9204420 | 0.0323731 |

It was verified from FIG. 7 and Table 5 that appearance of ripples in the color-reduction state was effectively suppressed when M2 was M1+5=11 where M2 was changed with respect to M1=6.

### Example 6

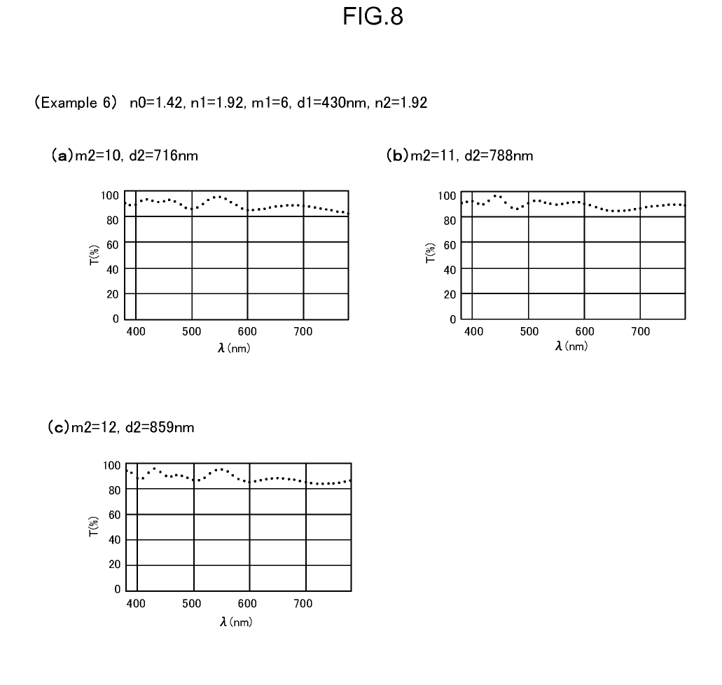

Example 6 used the electrochromic element which was different from Example 5 only in a point that NiO with a refractive index (n2) of 1.92 was used as the oxidation coloring-type solid electrochromic layer, and optical characteristics were similarly examined. Data of the obtained optical spectra were illustrated in FIG. 8. Values calculated regarding the average value and the standard deviation of the transmittance at this time were listed in Table 6. In FIG. 8 and Table 6, the transmittances employ values from 380 nm to 780 nm every 10 nm.

TABLE 6
n0 = 1.42, n1 = 1.92, d1 = 430 nm (m1 = 6), n2 = 1.92

| | | | | | Variation |
|---|---|---|---|---|---|
| m2 | | Average | Dispersion | Standard | ratio |
| (M2) | d2 (nm) | value Tm (%) | σ² | deviation σ | T_{CV} |
| 10 | 716 | 89.3047073 | 10.6981007 | 3.2707951 | 0.0366251 |
| 11 | 788 | 89.6735366 | 7.6172215 | 2.7599314 | 0.0307775 |
| 12 | 859 | 89.2491951 | 11.0838904 | 3.3292477 | 0.0373028 |

It was verified from FIG. 8 and Table 6 that appearance of ripples in the color-reduction state was suppressed when M2 was M1+5=11 where M2 was changed with respect to M1=6.

Hereinabove, it could be verified that ripples in the color-reduction state could be suppressed by setting the transparent electrolyte layer, the reduction coloring-type solid electrochromic layer and the oxidation coloring-type solid electrochromic layer to satisfy predetermined relations in the electrochromic element.

The electrochromic element of this invention is able to control spectral transmittance characteristics by an application state of a voltage, and in particular, ripples in a color-reduction state is suppressed by applying a voltage.

What is claimed is:

1. An electrochromic element comprising:
a transparent electrolyte layer;
a pair of solid electrochromic layers which sandwiches the transparent electrolyte layer, the pair of solid electrochromic layers being constituted by a pair of a reduction coloring-type solid electrochromic layer and an oxidation coloring-type solid electrochromic layer;
a pair of transparent conductive films which further sandwiches the pair of solid electrochromic layers, and
transparent support substrates which respectively support the pair of transparent conductive films, wherein
the pair of solid electrochromic layers is constituted by a reduction coloring-type solid electrochromic layer and an oxidation coloring-type solid electrochromic layer opposing each other, and wherein the electrochromic element satisfies:
n0 is different from either of n1 and n2,
d0 is 5 μm or more, and
d1 and d2 are provided to satisfy |λa−λb|≤50 nm, where
d0 is a thickness of the transparent electrolyte layer,
n0 is a refractive index of the transparent electrolyte layer with respect to light at a wavelength of 550 nm,
d1 is a thickness of the reduction coloring-type solid electrochromic layer,
n1 is a refractive index of the reduction coloring-type solid electrochromic layer with respect to light at a wavelength of 550 nm,
d2 is a thickness of the oxidation coloring-type solid electrochromic layer,
n2 is a refractive index of the oxidation coloring-type solid electrochromic layer with respect to light at a wavelength of 550 nm,
λa is a wavelength representing a maximum or a minimum which is the nearest to the wavelength of 550 nm in a spectral transmission spectrum due to interference of a stack having the transparent support substrate, the transparent conductive film, the reduction coloring-type solid electrochromic layer, and the transparent electrolyte layer in this order, and
λb is a wavelength representing a minimum or a maximum which is the nearest to the wavelength of 550 nm in a spectral transmission spectrum due to interference of a stack having the transparent electrolyte layer, the oxidation coloring-type solid electrochromic layer, the transparent conductive film, and the transparent support substrate in this order, where a corresponding wavelength is selected such that when λa is the maximum, λb is the minimum, and when λa is the minimum, λb is the maximum.

2. The electrochromic element according to claim 1, wherein
when λ1 is set as 550 nm, m1 is set as an integer number or a real number whose integer part M1 is positive and M1±0.3, and m2 is set as an integer number or a real number whose integer part M2 is positive and M2±0.3,
an optical film thickness (n1×d1) of the reduction coloring-type solid electrochromic layer is equal to (λ¼)×m1, and an optical film thickness (n2×d2) of the oxidation coloring-type solid electrochromic layer is equal to (λ¼)×m2, and
the integer part M1 and the integer part M2 are M1=M2±1, M2±3, M2±5, or M2±7.

3. The electrochromic element according to claim 2, wherein
the integer part M1 and the integer part M2 are M1=M2±1.

4. The electrochromic element according to claim 1, wherein
in a color-reduction state of the electrochromic element, average transmittance with respect to light at a wavelength of 380 to 780 nm is 75% or more.

5. The electrochromic element according to claim 1, wherein
in the color-reduction state of the electrochromic element, when transmittance with respect to light at a wavelength of 400 nm is set as T₄₀₀, transmittance with respect to light at a wavelength of 530 nm is set as T₅₃₀, and transmittance with respect to light at a wavelength of 630 nm is set as T₆₃₀, a value of the transmittance at each wavelength is within ±10% with respect to an average value of these three transmittances.

6. The electrochromic element according to claim 1, wherein
the electrolyte layer contains a material in a liquid state or a gel state.

7. The electrochromic element according to claim 6, wherein
the material includes a Li electrolyte in a liquid or a gel state.

8. The electrochromic element according to claim 1, wherein
the reduction coloring-type solid electrochromic layer contains WO₃, and the oxidation coloring-type solid electrochromic layer contains NiO.

9. The electrochromic element according to claim 1, wherein

|n0−n1|≥0.2, and |n0˜n2|≥0.2 are satisfied.

10. The electrochromic element according to claim 1, wherein

|n0−n1|≥0.3, and |n0−n2|≥0.3 are satisfied.

11. The electrochromic element according to claim 9, wherein
a relation of ∥n0−n1|−|n0−n2∥≤0.2 is satisfied.

12. The electrochromic element according to claim 1, wherein
a shielding layer is provided at one or both of a position between the reduction coloring-type solid electrochromic layer and the transparent electrolyte layer and a position between the transparent electrolyte layer and the oxidation coloring-type solid electrochromic layer.
